(19) United States
(12) Patent Application Publication
(10) Pub. No.: US 2026/0224070 A1
(43) Pub. Date: Aug. 6, 2026

(54) Liquid-Draining Frying Pan Device

(71) Applicant: Crystal Schaeffer, Hertford, NC (US)

(72) Inventor: Crystal Schaeffer, Hertford, NC (US)

(21) Appl. No.: 19/459,190

(22) Filed: Jan. 26, 2026

Related U.S. Application Data
(60) Provisional application No. 63/753,041, filed on Feb. 3, 2025.

(51) Int. Cl. A47J 37/10; A47J 36/02; A47J 36/06; A47J 36/38; A47J 45/06

(52) U.S. Cl. CPC A47J 37/108; A47J 36/025; A47J 36/064; A47J 36/38; A47J 45/061

(57) ABSTRACT

A liquid-draining frying pan device is provided. The device is comprised of a pan configured to facilitate the safe and efficient draining of cooking liquids while retaining food within the pan body. The device comprises a pan body that includes a handle affixed to the pan and which may include textured surfaces, and non-slip grip areas to improve control. The upper perimeter of the pan body is comprised of a lip which may be curved or angled inward to function as a food-retention ledge. More specifically, this lip directs liquid toward one or more funnels integrated into the outer wall of the pan, each having an interior opening beneath the lip and an exterior outlet. The funnels may be equipped with removable caps and strainer inserts to control liquid flow and prevent food escape. A lid is configured to attach to the pan body.

### CROSS-REFERENCE TO RELATED APPLICATION

The present application claims priority to, and the benefit of, U.S. Provisional Application No. 63/753,041, which was filed on February 3, 2025, and is incorporated herein by reference in its entirety.

### FIELD OF THE INVENTION

The present invention relates generally to the field of cookware. More specifically, the present invention relates to a pan configured to facilitate the safe and efficient draining of cooking liquids while retaining food within the pan body. Accordingly, the present disclosure makes specific reference thereto. Nonetheless, it is to be appreciated that aspects of the present invention are also equally applicable to other like applications, devices, and methods of manufacture.

### BACKGROUND

The process of draining liquid from a conventional frying pan often introduces multiple risks and inefficiencies. For example, when users attempt to pour out grease, butter, or other cooking liquids from a standard pan, there is a significant chance that solid food components within the pan may inadvertently spill out along with the liquid. This can result in food loss and increased cleanup time. Additionally, the physical act of tilting a hot pan to drain liquid, while simultaneously attempting to retain food with a separate utensil or lid, poses a safety hazard. Users may be exposed to hot surfaces or splashing grease, increasing the likelihood of burns. Traditional frying pans also fail to accommodate both right- and left-handed users in a symmetrical and ergonomic fashion. The lack of built-in features to direct and control the flow of liquids during draining operations further compounds these challenges. Moreover, users who require one-handed operation of cookware due to mobility limitations face additional barriers when attempting to strain liquids without spilling. While some external strainer accessories exist, they often fail to integrate seamlessly with the pan body and do not prevent spillage effectively. These persistent challenges demonstrate a need for a frying pan solution that inherently addresses liquid drainage, user safety, and food retention without introducing additional complexity.

Therefore, there exists a long-felt need in the art for a liquid-draining frying pan device that enables controlled drainage of liquids from a pan without displacing food from the pan. There also exists a long-felt need in the art for a liquid-draining frying pan device that minimizes the risk of burns and spillage during cooking operations. Moreover, there exists a long-felt need in the art for a liquid-draining frying pan device that allows single-handed operation and accommodates both right- and left-handed users.

The subject matter disclosed and claimed herein, in one embodiment thereof, comprises a liquid-draining frying pan device. The device is comprised of a pan configured to facilitate the safe and efficient draining of cooking liquids while retaining food within the pan body. The device comprises a pan body that includes a handle affixed to the pan and which may include textured surfaces, and non-slip grip areas to improve control. The upper perimeter of the pan body is comprised of a lip which may be curved or angled inward to function as a food-retention ledge. More specifically, this lip directs liquid toward one or more funnels integrated into the outer wall of the pan, each having an interior opening beneath the lip and an exterior outlet. The funnels may be equipped with removable caps and strainer inserts to control liquid flow and prevent food escape. A lid is configured to attach to the pan body and may include a handle with grip features. In one embodiment, the pan may be removably attached to the pan body using mechanical fasteners to prevent dislodgment of the lid from the pan body during draining.

In this manner, the liquid-draining frying pan device of the present invention accomplishes all the foregoing objectives and provides a pan that allows for safe and efficient draining of cooking liquids from the device without the loss of solid food. The inclusion of strainer inserts and removable caps further ensures that liquid can be selectively drained while food remains securely within the pan body. The dual-funnel design further accommodates both left- and right-handed users. The removable lid also enhances the containment of food within the pan body during draining operations. By addressing the limitations of conventional frying pans, the liquid-draining frying pan device offers a practical and comprehensive solution to common problems encountered during cooking.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a liquid-draining frying pan device. The device is a frying pan configured to improve the removal of liquids from the pan during cooking while reducing the risk of spills and unintentional displacement of food. More specifically, the device enables liquid to exit the frying pan while retaining food within the pan body.

The device is comprised of a frying pan body that may further be comprised of a heat-diffusing base configured to improve thermal distribution. A non-stick coating may be applied to the interior surface of the frying pan body.

The frying pan body is comprised of a handle that may be attached to the pan body using welds, rivets, adhesives, molded joints, or locking hinges. In one embodiment, the locking hinge allows the handle to fold for compact storage. The handle may be comprised of thermally insulating materials. A textured surface may be included on the handle to improve grip. A non-slip grip area may also be integrated using materials, optionally including the textured elements.

The frying pan body is further comprised of a lip positioned along the upper perimeter of the body. The lip may be continuous or segmented and may extend inward to function as a retaining ledge that prevents food from escaping while allowing liquid to drain. The lip also helps prevent spillage during mixing or stirring.

The lip may guide fluid toward one or more funnels integrated into the outer wall of the pan body. Each funnel may include an interior first opening beneath the lip and an exterior second opening for liquid discharge. In one embodiment, two funnels may be positioned on opposing sides of the pan body for ambidextrous use. Each funnel may be comprised of a removable cap to control liquid flow and may include strainer inserts at one or both openings to allow liquid to exit while retaining food.

The device may be comprised of a lid designed to match the geometry of the frying pan body. A gasket may be positioned along the lid perimeter to enhance sealing engagement with the pan body. The lid is comprised of a handle. The handle may be made from the same or a different material from the lid. The handle may be further comprised of a grip texture and a non-slip grip area. The lid may be removably attached to the pan body using friction-fit engagement or mechanical fasteners located on the lid and/or the pan body.

Accordingly, the liquid-draining frying pan device of the present invention is particularly advantageous as it provides a pan that allows for safe and efficient draining of cooking liquids from the device without the loss of solid food. The inclusion of strainer inserts and removable caps further ensures that liquid can be selectively drained while food remains securely within the pan body. The dual-funnel design further accommodates both left- and right-handed users. The removable lid also enhances the containment of food within the pan body during draining operations. By overcoming the limitations of conventional frying pans, the liquid-draining frying pan device offers a practical and comprehensive solution to common problems encountered during cooking.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of one potential embodiment of a liquid-draining frying pan device of the present invention wherein the lid is attached to the pan body in accordance with the disclosed architecture;

FIG. 2 illustrates an enhanced perspective view of a pan body of one potential embodiment of a liquid-draining frying pan device of the present invention in accordance with the disclosed architecture;

FIG. 3 illustrates an exploded perspective view of one potential embodiment of a liquid-draining frying pan device of the present invention wherein the lid is unattached to the pan body in accordance with the disclosed architecture; and

FIG. 4 illustrates a perspective view of one potential embodiment of a liquid-draining frying pan device of the present invention wherein the lid is attached to the pan body and the device is tilted while draining liquid from inside the pan body in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a liquid-draining frying pan device that enables controlled drainage of liquids from a pan without displacing food from the pan. There also exists a long-felt need in the art for a liquid-draining frying pan device that minimizes the risk of burns and spillage during cooking operations. Moreover, there exists a long-felt need in the art for a liquid-draining frying pan device that allows single-handed operation and accommodates both right- and left-handed users.

The present invention, in one exemplary embodiment, is comprised of a liquid-draining frying pan device. The device is comprised of a pan configured to facilitate the safe and efficient draining of cooking liquids while retaining food within the pan body. The device comprises a pan body that includes a handle affixed to the pan and which may include textured surfaces, and non-slip grip areas to improve control. The upper perimeter of the pan body is comprised of a lip which may be curved or angled inward to function as a food-retention ledge. More specifically, this lip directs liquid toward one or more funnels integrated into the outer wall of the pan, each having an interior opening beneath the lip and an exterior outlet. The funnels may be equipped with removable caps and strainer inserts to control liquid flow and prevent food escape. A lid is configured to attach to the pan body and may include a handle with grip features. In one embodiment, the pan may be removably attached to the pan body using mechanical fasteners to prevent dislodgment of the lid from the pan body during draining.

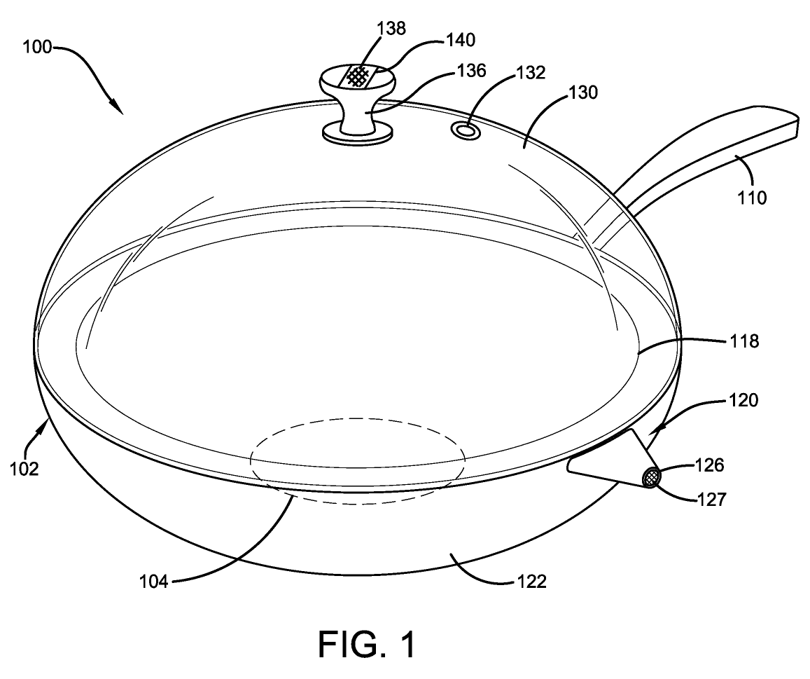

Referring initially to the drawings, FIG. 1 illustrates a perspective view of one potential embodiment of a liquid-draining frying pan device 100 of the present invention wherein the lid 130 is attached to the pan body 102 in accordance with the disclosed architecture. The device 100 is comprised of a frying pan configured to improve the draining of liquids during cooking operations while also reducing the risk of spills and unintentional displacement of food items from the pan. More specifically, the device 100 facilitates cleaner and safer food preparation by enabling liquid to exit the device 100 while food remains securely retained within the body 102 of the device 100.

The device 100 is comprised of a pan body 102. The frying pan body 102 may be of any shape including but not limited to circular, oval, elliptical, polygonal, or irregular configurations. The frying pan body 102 may vary in size to accommodate a range of cooking applications. The frying pan body 102 may be made from one or more materials including but not limited to any combination of stainless steel, aluminum, copper, cast iron, carbon steel, titanium, or layered composite materials. In one embodiment, the frying pan body 102 may be comprised of a heat-diffusing base 104. The heat-diffusing base 104 may be comprised of but not limited to aluminum cores, copper inserts, sandwich-layered conductive alloys, or encapsulated thermal plates configured to enhance thermal distribution across the cooking surface of the body 102.

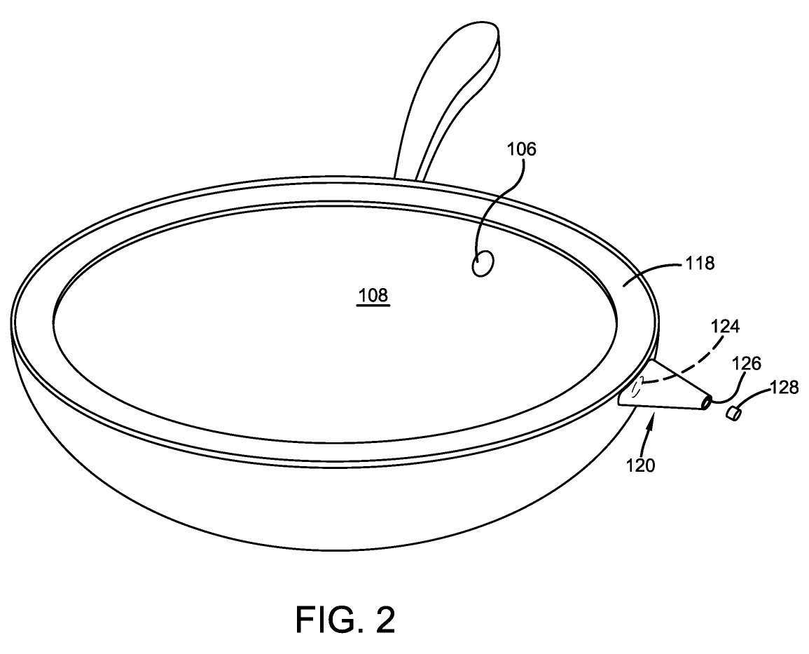

The frying pan body 102 may be comprised of a non-stick coating 106 applied to the interior surface 108 of the body 102, as seen in FIG. 2. The non-stick coating 106 may include but is not limited to polytetrafluoroethylene (PTFE), ceramic-based coatings, silicone-infused surfaces, diamond-infused coatings, or hybrid non-stick coatings combining multiple materials for improved durability and food release properties.

The body 102 is comprised of a handle 110. The handle 110 may be configured in various geometries including but not limited to linear, contoured, offset, or ergonomically shaped profiles to improve comfort and control during use. The handle 110 may be secured to the frying pan body 102 using fasteners 112. The fasteners 112 may include but are not limited to welds, rivets, adhesive bonds, integrally molded joints, or locking hinges. In one embodiment, a locking hinge configuration may permit the handle 110 to fold along the body 102 for compact storage.

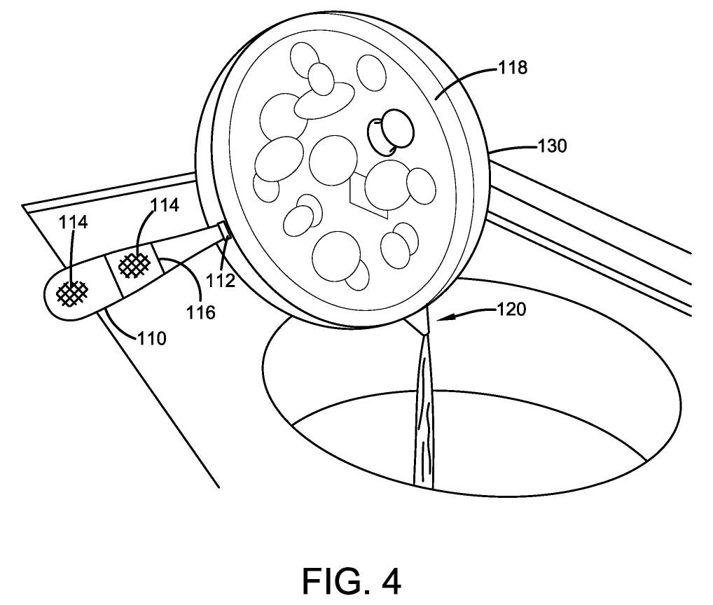

The handle 110 may be comprised of the same material as the frying pan body 102 or a different material selected to provide thermal insulation such as but not limited to phenolic resin, high-temperature thermoplastics, silicone-coated metal, or overmolded rubber composites. In one embodiment, the handle 110 may be comprised of a texture 114 including but not limited to grooves, stippling, knurling, ribbing, or raised protrusions to improve user grip. A non-slip grip area 116 may be included on the handle 110, which may be comprised of materials such as thermoplastic elastomer (TPE), silicone, or natural rubber. The non-slip grip area 116 may be further comprised of the texture 114 to enhance control during manipulation of the handle 110, as seen in FIG. 4.

The frying pan body 102 is further comprised of a lip 118 extending along an upper perimeter edge of the body 102, as seen in FIGS. 1-4. The lip 118 may be continuous or segmented and may adopt a flat, angled, or curved profile. The lateral axis of the lip 118 may vary between 1 and 179 degrees relative to the longitudinal axis of the frying pan body 102. In one embodiment, the lip 118 may project inward into the body 102 and may taper or flare in profile. During draining operations, the lip 118 may function as a retaining ledge to prevent food items from escaping the body 102 while allowing liquid to exit the body 102 (as seen in FIG. 4), as will be explained more fully below. The lip 118 also prevents food or liquid from escaping the body 102 while stirring or mixing.

The lip 118 may be configured to direct fluid flow within the body 102 toward one or more funnels 120 that provide fluid communication between the interior of the body 102 and the external environment. Each funnel 120 may be generally triangular in shape and may be positioned along the outer wall 122 of the body 102, as seen in FIG. 2. The funnel 120 may include a first opening 124 located beneath the lip 118 on the interior surface 124 of the body 102. The first opening 124 permits liquid to pass out of the body 102 and exit through a second opening 126 of the funnel 120. The funnel 120 may exhibit a straight, tapered, or curved geometry in different embodiments. In one embodiment, a pair of funnels 120 may be located on opposite sides of the body 102 to accommodate both right- and left-handed users. In one embodiment, each funnel 120 may be comprised of a removable cap 128, as seen in FIG. 2. The removable cap 128 may selectively obstruct the flow of liquid through the funnel 120 when draining is not desired. In one embodiment, one or both of the openings 124,126 are comprised of a strainer insert 127 that prevents food from exiting the body 102 but allows liquid to pass through the funnel 120. The spacing of the strainer inserts 127 may vary in different embodiments.

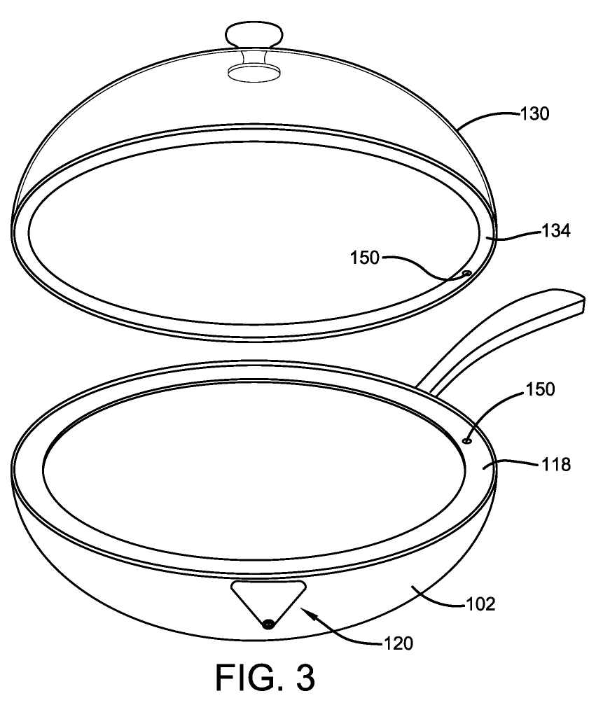

The device 100 may be comprised of a lid 130. The lid 130 may be shaped to match the perimeter geometry of the frying pan body 102 and may adopt a flat, domed, ridged, or stepped profile. The lid 130 may be manufactured from one or more materials including but not limited to any combination of tempered glass, stainless steel, aluminum, carbon steel, or polymer composites. The lid 130 may be opaque, translucent, or transparent and may include at least one vent hole 132 to allow controlled release of steam or pressure during cooking. In some embodiments, the lid 130 may be further comprised of a gasket 134 (as seen in FIG. 3) positioned along its perimeter to improve sealing engagement with the frying pan body 102.

The lid 130 is comprised of a handle 136. The handle 136 may be positioned centrally or offset on the lid 130 and may be formed in configurations such as looped, arched, vertical, or horizontal geometries. The handle 136 may be comprised of the same material as the lid 130 or of a different non-heat-conductive material such as silicone, thermoplastic, or rubber-coated metal. The handle 136 may be further comprised of a grip texture 138 such as but not limited to knurls, dimples, or ridges. In addition, the handle 136 may be comprised of a non-slip grip area 140. The non-slip grip area 140 may be comprised of materials such as thermoplastic elastomer, silicone, or rubber and may be formed integrally or overmolded onto the handle 136. In some embodiments, the grip area 140 may be comprised of the texture 138 to improve handling during use.

The lid 130 may be removably attached to the body 102. The attachment mechanism may be comprised of friction-fit engagement or mechanical fasteners 150 disposed on the lid 130 and/or body 102, as seen in FIG. 3. The fasteners 150 may include but are not limited to magnets, male and female fasteners, tongue and groove, bayonet mounts, threaded collars, quarter-turn locks, or snap-fit couplings. The fasteners 150 may be configured to prevent unintentional dislodgment of the lid 130 during draining operations.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “liquid-draining frying pan device” and “device” are interchangeable and refer to the liquid-draining frying pan device 100 of the present invention.

Notwithstanding the foregoing, the liquid-draining frying pan device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the liquid-draining frying pan device 100 as shown in the FIGS. are for illustrative purposes only, and that many other sizes and shapes of the liquid-draining frying pan device 100 are well within the scope of the present disclosure. Although the dimensions of the liquid-draining frying pan device 100 are important design parameters for user convenience, the liquid-draining frying pan device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid-draining frying pan device comprising:
a pan body comprised of a lip extending along an upper perimeter edge of the pan body;
wherein the lip extends inward into the pan body;
wherein the pan body is comprised of a funnel; and
further wherein the funnel is comprised of a first opening located beneath the lip on an interior surface of the pan body and a second opening on the funnel outside of the pan body.

2. The liquid-draining frying pan device of claim 1, wherein the pan body is comprised of a heat-diffusing base.

3. The liquid-draining frying pan device of claim 1, wherein the interior surface is comprised of a non-stick coating.

4. The liquid-draining frying pan device of claim 1 further comprised of a removable cap.

5. The liquid-draining frying pan device of claim 1, wherein the first opening or the second opening is comprised of a strainer insert.

6. A liquid-draining frying pan device comprising:
a pan body comprised of a lip extending along an upper perimeter edge of the pan body;
wherein the lip extends inward into the pan body;
wherein the pan body is comprised of a funnel;
wherein the funnel is comprised of a first opening located beneath the lip on an interior surface of the pan body and a second opening on the funnel outside of the pan body; and
a lid.

7. The liquid-draining frying pan device of claim 6, wherein the lid is comprised of a vent hole.

8. The liquid-draining frying pan device of claim 6, wherein the lid is comprised of a gasket.

9. The liquid-draining frying pan device of claim 6, wherein the pan body is comprised of a first handle.

10. The liquid-draining frying pan device of claim 6, wherein the lid is comprised of a second handle.

11. The liquid-draining frying pan device of claim 9, wherein the first handle is comprised of a first texture.

12. The liquid-draining frying pan device of claim 9, wherein the second handle is comprised of a second texture.

13. The liquid-draining frying pan device of claim 9, wherein the first handle attaches to the pan body via a locking hinge.

14. The liquid-draining frying pan device of claim 6, wherein the lid is transparent.

15. A liquid-draining frying pan device comprising:
a pan body comprised of a lip extending along an upper perimeter edge of the pan body;
wherein the lip extends inward into the pan body;
wherein the pan body is comprised of a funnel;
wherein the funnel is comprised of a first opening located beneath the lip on an interior surface of the pan body and a second opening on the funnel outside of the pan body; and
a lid comprised of a first fastener, wherein the first fastener attaches to a second fastener of the pan body.

16. The liquid-draining frying pan device of claim 15, wherein the pan body is comprised of a heat-diffusing base.

17. The liquid-draining frying pan device of claim 15, wherein the interior surface is comprised of a non-stick coating.

18. The liquid-draining frying pan device of claim 15 further comprised of a removable cap.

19. The liquid-draining frying pan device of claim 15, wherein the first opening or the second opening is comprised of a strainer insert.

20. The liquid-draining frying pan device of claim 15, wherein the first fastener is comprised of a tongue and the second fastener is comprised of a groove.
